(19) United States
(12) Patent Application Publication
(10) Pub. No.: US 2021/0068014 A1
(43) Pub. Date: Mar. 4, 2021

(54) TECHNIQUES AND ARCHITECTURES FOR COLLABORATIVE SCANNING BY OFFLOADING SCAN FUNCTIONALITY TO CLIENT DEVICES

(71) Applicant: Hewlett Packard Enterprise Development LP, Houston, TX (US)

(72) Inventors: Mohd Shahnawaz SIRAJ, Santa Clara, CA (US); Sachin Ganu, Santa Clara, CA (US); Aidan Doyle, Santa Clara, CA (US)

(21) Appl. No.: 16/552,707

(22) Filed: Aug. 27, 2019

(51) Int. Cl. H04W 36/00; H04W 24/10; H04W 48/16

(52) U.S. Cl. CPC H04W 36/0085; H04W 48/16; H04W 24/10; H04W 36/0058

(57) ABSTRACT

Techniques and mechanisms for offloading of off-channel scanning. Characteristics corresponding to wireless client devices within a wireless network are evaluated. A request is sent from a wireless access point of the wireless network to one or more selected wireless client devices from wireless client devices. The request causes the one or more selected wireless clients to perform off-channel scanning. Reports are received from the one or more selected wireless client devices having information gathered by the off-channel scanning performed by the selected wireless client devices. Information from the reports is utilized to perform network setting modification.

### TECHNICAL FIELD

Embodiments relate to techniques for managing off-channel scan functionality in a wireless network having one or more access points and multiple client devices. More particularly, embodiments relate to techniques for selecting one or more client devices within the wireless network to perform scanning operations and report to at least one access point.

### BACKGROUND

As wireless networks become more complex and attempt to become more efficient, additional information may be gathered to be utilized. This additional information can be helpful, for example, to maintain network topology information, or communicating device capability information, or handoff support. Various techniques and strategies have been provided for gathering this additional information. However, current techniques and strategies suffer from various limitations, for example, interfering with timing requirements and/or consuming excessive bandwidth.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram of one embodiment of a wireless network having an access point and multiple client devices.

FIG. 2 is a conceptual illustration of one embodiment of a request message that can be utilized to provide the functionality described herein.

FIG. 3 is a conceptual illustration of one embodiment of a report message that can be utilized to provide the functionality described herein.

FIG. 4 is a flow diagram of one embodiment for selecting channels and candidate STAs for off-channel scanning operations.

FIG. 5 is an example non-preferred channel report that can be utilized.

FIG. 6 is a block diagram of a scan offload system that can provide functionality as described herein.

### DETAILED DESCRIPTION

In the following description, numerous specific details are set forth. However, embodiments of the invention may be practiced without these specific details. In other instances, well-known structures and techniques have not been shown in detail in order not to obscure the understanding of this description.

The IEEE 802.11 family of standards is very widely used to provide wireless network functionality. While not defined within the IEEE 802.11 standards, it is common for wireless access points (APs) to periodically go off channel to perform background scanning or other operations. This can improve the overall efficiency of the wireless network, but must be managed and provided within the requirements of the relevant standards.

One common situation is for the AP transmit on a channel other than the Basic Service Set (BSS) channel to, for example, discover rogue APs and clients. Typically, APs perform these operations opportunistically to minimize the impact to their BSS and go to another channel (i.e., operate “off channel”) immediately after sending the beacon and then come back to the BSS channel before the next Target Beacon Transmission Time (TBTT).

While this is the basic off-channel functionality is described above, more sophisticated network functionality, for example, Multiband Operation (MBO) and Optimized Connectivity Experience (OCE) can provide an enhanced network experience, but increase the complexity of off-channel scanning. Multiband operation and optimized connectivity experience are based on IEEE 802.11k and IEEE 802.11v standards.

Currently, MBO is required for IEEE 802.11ax certification and OCE is an optional certification that includes MBO as a pre-requisite. MBO allows APs and STAs to exchange information to allow the network as a whole to utilize the available spectrum more efficiently. OCE allows APs and stations (STAs) to exchange information to optimize the connectivity experience for the end user while improving efficiency by reducing overhead.

Because AP off-channel behavior is not defined in the IEEE 802.11 standards, client devices may not be aware of the timing of the off-channel behavior. When the APs go off-channel, there is a potential window where the client devices may send traffic to the AP, but the traffic is not received because the AP is off-channel. This results in retries and packet loss. Some clients may even leave the BSS. Thus, efficient management of off-channel functionality can greatly improve the end user experience.

The addition of MBO and OCE can make the off-channel traffic congestion/loss situation worse if not managed efficiently. Currently, OCE leverages Fast Initial Link Setup (FILS) as defined in the IEEE 802.11ai standard to accelerate the AP discovery process. The FILS beacon is a very short beacon used to advertise neighboring APs and is transmitted every 20 milliseconds. FILS beacons only contain necessary elements for discovery. Because the FILS beacons occur every 20 milliseconds, the timing limitations on off-channel scanning become even more challenging.

Described herein are techniques to intelligently offload scanning operations to one or more connected client devices. This allows the APs to effectively manage the scanning process, but does not require the APs to perform all of the scanning operations. This can, for example, allow the APs to be on-channel for the FILS beacons, which may be difficult to accomplish if the APs performs all off-channel scanning operations.

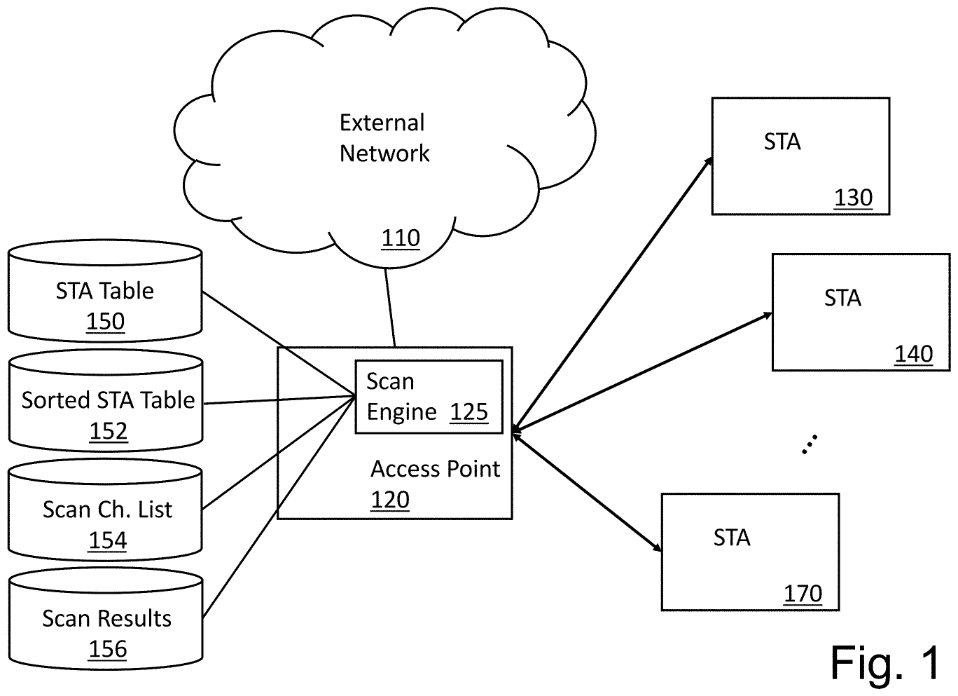

FIG. 1 is a block diagram of one embodiment of a wireless network having an access point and multiple client devices. The example network of FIG. 1 is a simple example and much more complicated real-world networks can be supported.

Access point 120 provides access to external network 110 for any number of network stations (e.g., 130, 140, 170). The client devices can be any type of wireless-enabled electronic devices, for example, desktop computers, laptop computers, tablets, smartphones, wearable devices, environmental sensors/controllers, etc.

In general, access point 120 is a hardware networking device that allows one or more client devices to access larger networks (e.g., external network 110) using one or more radio frequency links. Access point 120 can support, for example, some or all of the IEEE 802.11 family of standards and other suitable standards. Access point 120 can be a standalone device connected to a gateway, router or other intermediate device (not illustrated in FIG. 1). External network 110 can be any type of network, for example, the Internet.

As described in greater detail below, Access point 120 can operate to request that one or more of STA 130, 140 and 170 perform scanning or other off-channel functionality and report the results back to access point 120. In one embodiment, access point 120 includes scan engine 125 that can support coordination of scanning by one or more client devices.

The examples provided herein are mostly based on beacon request/report mechanisms; however other types of request/report measurements can also be supported. These include, for example, beacon, frame, channel load, noise histogram, STA statistics, location configuration information (LCI), neighbor report, link measurement, transmit stream/category measurement.

In some embodiments, several measurement request frames (e.g., beacon, frame, load, noise histogram) can be utilized to collect information from scanning. If sufficient information can be gathered utilizing these techniques the AP may have no need to go off-channel.

In the example of FIG. 1, various tables and data stores (e.g., 150, 152, 154, 156) are illustrated. While these are illustrated as distinct entities external to access point 120, one or more can be maintained by access point 120, distributed among multiple access points, maintained by other network devices, etc.

In on embodiment, STA table 150 is utilized to maintain a list of STAs within the wireless network. STA table 150 can be maintained by scan engine 125, within one or more APs, or in any other manner in which the relevant information is available to operate as described herein. In one embodiment, the STAs are sorted according to relevant parameters and maintained in sorted STA table 152. In some embodiments, the sorting of STAs occurs periodically according to time (e.g., every 30 seconds, every 3 minutes). In alternate embodiments, different triggers can be utilized to cause the sorting of the STAs.

In one embodiment, sorted STA table 152 and scan channel list 154 can be utilized to determine a STA and channel list. This can be accomplished by scan engine 125, a component of one or more APs or another element. In one embodiment, scan engine 125 sends beacon request(s) to one or more selected STAs (e.g., 130, 140, 170) based on the STA and channel list. Scan engine 125 receives one or more beacon reports from selected STA(s). Scan engine 125 can cause the information from the report(s) to be stored as scan results 156.

In various embodiments, one or more of the following parameters can be utilized to select scan channels for STAs and candidate STAs for various channels. In one embodiment, the number of IEEE 802.11k capable STAs are available to an AP is evaluated. In one embodiment, if there are no IEEE 802.11k capable STAs, the AP can scan in the legacy manner using its own radio interfaces.

In some embodiments, the activity level of each STA (e.g., 130, 140, 170) can be considered. For example, if a STA is active and receiving or transmitting packets above a pre-selected threshold, the AP may not select the STA for scanning. In some embodiments, these thresholds can be tunable to minimize the impact of scanning on network performance.

In some embodiments, the AP can determine if STAs are stationary. That is, STAs can be classified as stationary or mobile based on mechanisms such as tracking Received Signal Strength Indicator (RSSI) levels. This information can also be determined from other location services. In general, the quality of the beacon report from a stationary STA would be more consistent than a mobile STA.

In some embodiments, the location of the STA within the spatial/radio frequency (RF) distribution of the network can be considered in the selection of STA(s) for scanning. For example, the AP can get scan information from locations across the entire network. Currently, a small number of APs give information from just those deployment points. With scan offload to STAs, there are many more options so STAs may be selected to provide the desired information (e.g., STA near the halfway point between the AP and network edge or other AP, STA near the edge of coverage, network corners).

In some embodiments, the battery status of the STA can be considered. In enterprise deployment situations, for example, laptops and wireless printers are connect to power most of the time. In some embodiments device classification mechanisms can be utilized to gather that information. In some embodiments, these types of clients can be selected more frequently for scan offloading because battery life is not an issue for these STAs.

In some embodiments, a round robin strategy can be utilized. This strategy my more evenly spread the scanning load across the entire BSS. For example, the AP can scan

N_ch/N_cl

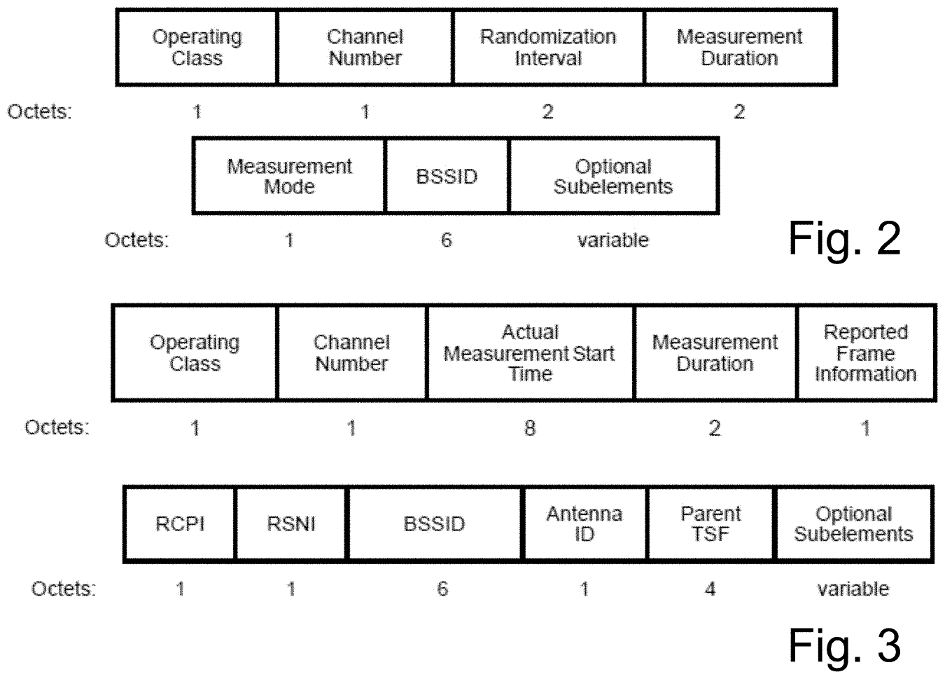

channels where N_ch is the number of channels to be scanned and N_cl is the number of STAs that are IEEE 802.11k capable. Various embodiments of IEEE 802.11k compatible functionality are described below with respect to FIGS. 2 and 3.

In some embodiments, a STA can be assigned multiple channels to scan an report on. In some embodiments, the power save state of the STA is considered. For example, a power saving STA can be a more suitable candidate for assigning multiple channels in the scan request. In some embodiments, the number of channels and dwell time can be tunable based on network/AP conditions and needs. Traffic type (e.g., active voice call, video streaming) can also be considered in STA selection.

In various embodiments, STA capabilities can be considered in selecting STAs for offload scan. The MBO standard specifies two modes that can be utilized by the STAs to send the beacon report (e.g., active and passive). In passive mode, the STAs send the cached scan information collected from previous scans. In active mode, the STAs perform on-demand scan operations and scan the channels specified in the Beacon Request. In some embodiments, the AP can select STAs intelligently based on this capability to obtain the optimal number of recent beacon reports. This capability can be validated from the Association Request frame that contains a Radio Management (RM) Enabled Capabilities field with bit 4 (Beacon Report, Passive Mode) and bit 5 (Beacon Report, Active Mode) both set to 1.

FIG. 2 is a conceptual illustration of one embodiment of a request message that can be utilized to provide the functionality described herein. The IEEE 802.11k specification defines the Radio Measurement Request and Radio Measurement Report feature, which allows the APs to request that their connected STAs perform radio measurements and send the report back in one or more Radio Measurement Report frames (e.g., a Beacon Request resulting in one or more Beacon Reports).

The example of FIG. 2 corresponds to the IEEE 802.11k specification; however, other configurations can also be used to accomplish the functionality described herein. The IEEE 802.11k specification provides the functionality for an AP to request radio measurement information from one or more STAs. The information can be provided in the form of a report message (as illustrated in FIG. 3). These request and report messages can be used, for example, to provide link information between the AP and the STA.

In various embodiments, the Basic Service Set Identifier (BSSID) field indicates the BSSID of the BSS(s) for which a beacon report is requested. When requesting beacon reports for all BSSs on the channel, the BSSID field contains the wildcard BSSID, otherwise the BSSID field contains a specific BSSID for a single BSS.

As described herein, these mechanisms within the IEEE 802.11k standard can be utilized to allow APs to gather information from STAs, for example, by off-channel scanning. That information can be used by the APs to streamline subsequent authentications for new STAs, for example. Other examples include potential handoff targets, management of crowded networks (e.g., sports stadiums, shopping malls, music venues).

FIG. 3 is a conceptual illustration of one embodiment of a report message that can be utilized to provide the functionality described herein. In various embodiments, the Radio Measurement Request and Report messages are utilized according to the IEEE 802.11 standards; however, in alternate embodiments, other configurations can also be supported.

Described in greater detail herein, are techniques and mechanisms to evaluate and select STAs to be utilized to offload scanning operations and/or to determine a channel assigned to each STA for scanning. This offloaded scanning functionality can be supported using the message structure illustrated in FIG. 3. In alternate embodiments, other structures can be utilized. In various embodiments, neighborhood and other information can be gathered for all allowed channels from connected STAs. In some embodiments, connected STAs are selected such that the overall benefit in terms of performance and experience is greater than the cost to the STAs.

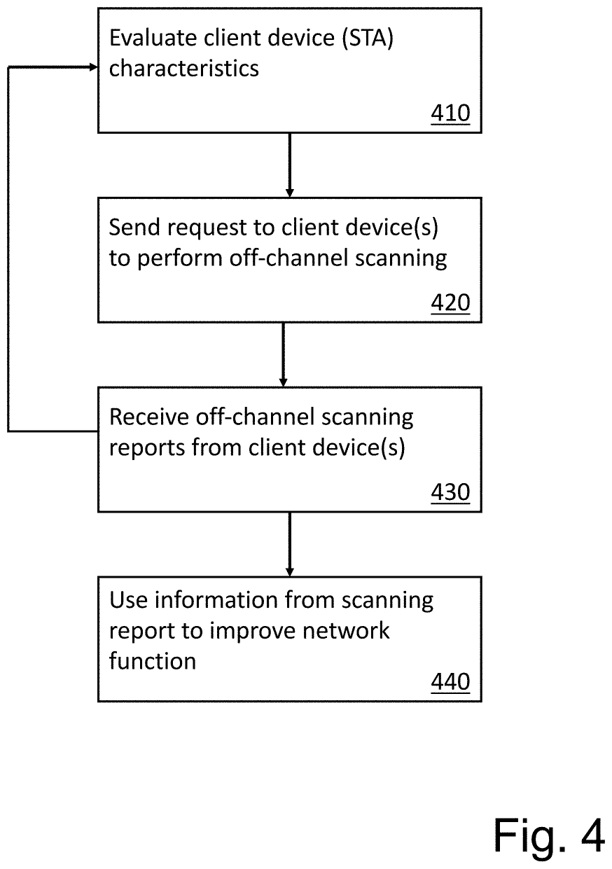

FIG. 4 is a flow diagram of one embodiment for selecting channels and candidate STAs for off-channel scanning operations. The process of FIG. 4 can be performed by, for example, scan engine 125.

In one embodiment, an AP can evaluate one or more characteristics of STAs within the network, 410. These characteristics can include, for example, battery level, movement speed, movement direction, bandwidth utilization, physical position within the network, physical position with respect to one or more other STAs. Other examples include, processor model and/or speed in the STA, available memory, operating system type, operating system version, security level, etc. Additional and/or different characteristics can be utilized.

In some embodiments, IEEE 802.11k standard mechanisms can be utilized to gather the characteristics information. In other embodiments, other mechanisms can be utilized to gather information. For example, a user can opt out or opt in through a user interface. The gathered STA information can be stored, for example, in STA table 150 and or sorted STA table 152 (illustrated in FIG. 1). In some embodiments, the gathered characteristics can be utilized as part of the sorting process. Other characteristics storage management mechanisms can also be used.

The AP can send one or more requests to STAs to perform off-channel scanning, 420. As discussed above, this request can be in the form of an IEEE 802.11k Radio Measurement Request message. In other embodiments, other messaging formats can be utilized. The request messages can be sent to any number of STAs in the network and are not required to be sent to all STAs in the network.

The AP can receive reports from one or more STAs having information from the requested off-channel scanning, 430. In some embodiments, the report can be in the form of an IEEE 802.11k Radio Measurement Report message. In other embodiments, different report messaging can be supported. The received reports can provide information gathered by the respective STAs during one or more off-channel scans. The report information can include, for example, information on sources of interference, rouge STAs, rouge networks, neighborhood and other information for allowed channels for STAs, load information, noise information, etc.

The information received from the reports can be utilized to perform subsequent evaluations of STA characteristics, 410. This can help the AP to have current network information. The updated STA characteristics can be used to update the STA list (e.g., STA table 150 and/or sorted STA table 152). The updated characteristic information can be utilized for subsequent requests (420).

In one embodiment, information used from scanning can be utilized to improve network function, 440. This can be, for example, updating STA information to be used for streamlined handoff or authentication. As another example, some portion of the network configuration (e.g., channel assignments, security configurations) can be modified in response to information received via one or more of the reports. Even without network function modification, the network utilizing the offloading techniques described herein will be more efficient than traditional networks, because fewer retires and fewer dropped frames will occur. Further, the distribution of information gathering will result in a faster and more efficient collection of useful information because information can be gathered in parallel from multiple sources. This is not possible when the AP is the source of off-channel information.

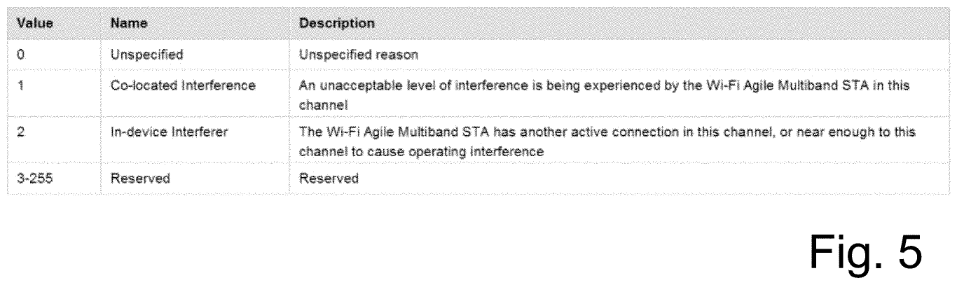

In some embodiments, Agile Multiband STAs use the non-preferred channel report attribute to inform the AP of the channels it would prefer not to scan or will not operate in. The STA can also indicate the reasons for this condition. The table of FIG. 5 can be utilized for this purpose. The information provided in the non-preferred channel report can be utilized by the AP to request the corresponding STA to scan the specified non-preferred channels more frequently to check if the interfering sources are still present, and/or refresh the STA cache to get updated results.

The techniques described herein can provide several advantages. For example, there can be no service interruption to the entire BSS when a STA rather than the AP performs the scanning operations. In the situation of OCE capable APs, no FILS beacons are missed by the AP. Improved overall performance and connectivity experiences can be provided. More efficient and lossless background AP scanning can be provided. A reduction in the loss of packets from connected STAs when the AP would go off-channel can be provided.

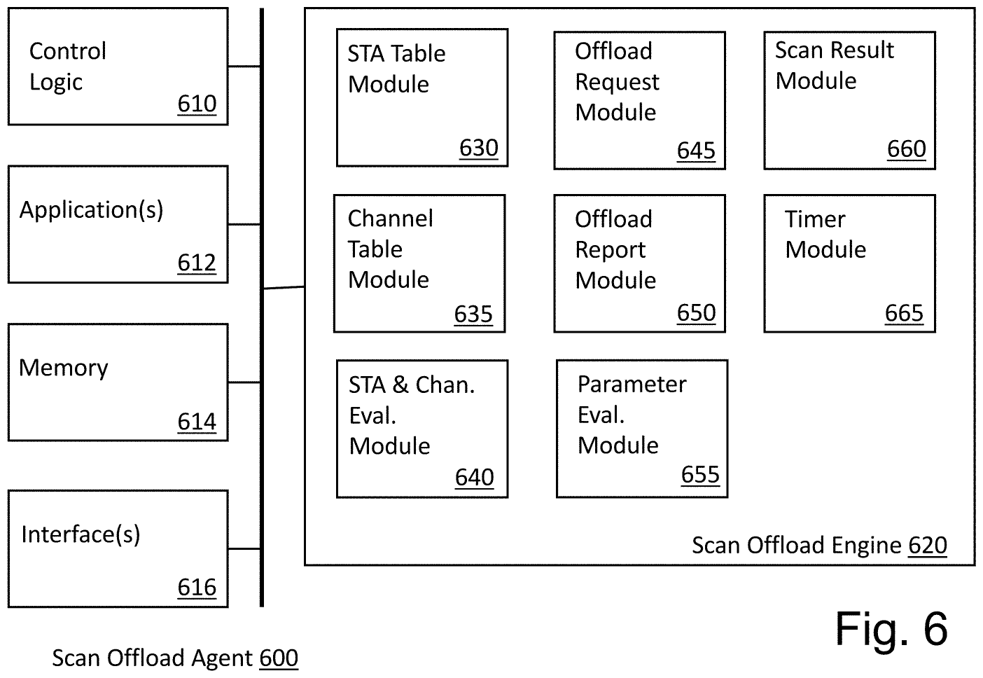

FIG. 6 is a block diagram of a scan offload system that can provide functionality as described herein. In one embodiment, one or more scan offload agents may exist and/or operate within the host wireless network. The agent of FIG. 6 may provide functionality as described, for example, with respect to FIGS. 1-5. The agent of FIG. 6 may also provide additional functionality.

In one embodiment, scan offload agent 600 includes control logic 610, which implements logical functional control to direct operation of scan offload agent 600, and/or hardware associated with directing operation of scan offload agent 600. Logic may be hardware logic circuits and/or software routines. In one embodiment, scan offload agent 600 includes one or more applications 612, which represent a code sequence and/or programs that provide instructions to control logic 610.

Scan offload agent 600 includes memory 614, which represents a memory device and/or access to a memory resource for storing data and/or instructions. Memory 614 may include memory local to scan offload agent 600, as well as, or alternatively, including memory of the host system on which scan offload agent 600 resides. Scan offload agent 600 also includes one or more interfaces 616, which represent access interfaces to/from (an input/output interface) scan offload agent 600 with regard to entities (electronic or human) external to scan offload agent 600.

Scan offload agent 600 also includes scan offload engine 620, which represents one or more functions or module that enable scan offload agent 600 to provide the index backups as described above. The example of FIG. 6 provides several modules that may be included in scan offload engine 620; however, different and/or additional modules may also be included.

Example modules that may be involved in providing buffer management functionality described herein include, for example, STA table module 630, channel table module 635, STA and channel evaluation module 640, offload request module 645, offload report module 650, parameter evaluation module 655, scan result module 660 and timer module 665. As used herein, a module refers to routine, a subsystem, logic circuit, microcode, etc., whether implemented in hardware, software, firmware or some combination thereof.

In one embodiment, STA table module 630 functions to manage and maintain a table of available STAs (e.g., 150 in FIG. 1). STA table module 630 can evaluate and/or manage additional network topology information. In one embodiment, channel table module 635 functions to manage and maintain a table of available channels (e.g., 154 in FIG. 1). Channel table module 635 can evaluate and/or manage additional network topology information.

In one embodiment, STA and channel evaluation module 640 can function to utilize STA information and channel information (e.g., from 630 and 640) to generate and/or maintain the STA and channel list that can be utilized to request offloaded STA channel scan operations.

In one embodiment, offload request module 645 can function to generate, transmit and/or track requests to STAs to perform off-channel scanning as described in greater detail above. In one embodiment, offload report module 650 can function to receive and/or track reports from STAs in response to off-channel scanning as described in greater detail above.

In one embodiment, parameter evaluation module 655 can function to evaluate the various parameters of available STAs to determine the frequency and/or requests to STAs to perform off-channels scanning and reporting back to one or more APs. In one embodiment, scan report module can gather and analyze reports from APs and utilize information from the reports to provide relevant information to the APs. In one embodiment, timer module 655 can provide timer functionality that can be used in prioritizing STAs and or channels.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A wireless network access point comprising:
a first wireless interface to receive network traffic from wireless client devices;
a scan engine to manage off-channel scanning by wireless client devices connected via the first wireless interface, the scan engine to:
evaluate one or more characteristics corresponding to the wireless client devices,
send a request to one or more selected wireless client devices from wireless client devices, the request to cause the one or more selected wireless clients to perform off-channel scanning,
receive reports from the one or more selected wireless client devices having information gathered by the off-channel scanning performed by the selected wireless client devices,
utilizing information from the reports to perform network setting modification.

2. The wireless access point of claim 1 wherein communications with the selected wireless client devices is compliant with IEEE 802.11k and IEEE 802.11v standards.

3. The wireless access point of claim 2 wherein the communications with the selected wireless clients utilizes at least the Radio Measurement Request and Radio Measurement Report features of the IEEE 802.11k standards.

4. The wireless access point of claim 1 wherein the information gathered by the off-channel scanning comprises at least beacon and frame information.

5. The wireless access point of claim 4 wherein the information gathered by the off-channel scanning further comprises channel load information and noise histogram information.

6. The wireless access point of claim 1 wherein the selected wireless client devices are selected based on activity levels for the wireless client devices.

7. The wireless access point of claim 1 wherein the selected wireless client devices are selected based on whether the wireless client devices are stationary or mobile.

8. The wireless access point of claim 1 wherein the selected wireless client devices are selected based on location of the wireless client devices within the spatial distribution of the host wireless network.

9. A non-transitory computer-readable medium having stored therein instructions that, when executed by one or more processors, are configurable to cause the one or more processors to:
evaluate one or more characteristics corresponding to wireless client devices within a wireless network;
cause a request to be sent from a wireless access point of the wireless network to one or more selected wireless client devices from wireless client devices, the request to cause the one or more selected wireless clients to perform off-channel scanning;
receive, with the wireless access point, reports from the one or more selected wireless client devices having information gathered by the off-channel scanning performed by the selected wireless client devices; and
utilize information from the reports to perform network setting modification.

10. The non-transitory computer-readable medium of claim 9 wherein communications with the selected wireless client devices is compliant with IEEE 802.11k and IEEE 802.11v standards.

11. The non-transitory computer-readable medium of claim 10 wherein the communications with the selected wireless clients utilizes at least the Radio Measurement Request and Radio Measurement Report features of the IEEE 802.11k standards.

12. The non-transitory computer-readable medium of claim 9 wherein the information gathered by the off-channel scanning comprises at least beacon and frame information.

13. The non-transitory computer-readable medium of claim 12 wherein the information gathered by the off-channel scanning further comprises channel load information and noise histogram information.

14. The non-transitory computer-readable medium of claim 9 wherein the selected wireless client devices are selected based on activity levels for the wireless client devices.

15. The non-transitory computer-readable medium of claim 9 wherein the selected wireless client devices are selected based on whether the wireless client devices are stationary or mobile.

16. The non-transitory computer-readable medium of claim 9 wherein the selected wireless client devices are selected based on location of the wireless client devices within the spatial distribution of the host wireless network.

17. A method comprising:
evaluating one or more characteristics corresponding to wireless client devices within a wireless network;
causing a request to be sent from a wireless access point of the wireless network to one or more selected wireless client devices from wireless client devices, the request to cause the one or more selected wireless clients to perform off-channel scanning;
receiving, with the wireless access point, reports from the one or more selected wireless client devices having information gathered by the off-channel scanning performed by the selected wireless client devices; and
utilizing information from the reports to perform network setting modification.

18. The method of claim 17 wherein communications with the selected wireless client devices is compliant with IEEE 802.11k and IEEE 802.11v standards.

19. The method of claim 18 wherein the communications with the selected wireless clients utilizes at least the Radio Measurement Request and Radio Measurement Report features of the IEEE 802.11k standards.

20. The method medium of claim 17 wherein the information gathered by the off-channel scanning comprises at least beacon and frame information.
